(19) United States
(12) Patent Application Publication
(10) Pub. No.: US 2005/0126016 A1
(43) Pub. Date: Jun. 16, 2005

(54) Blade

(76) Inventor: Christopher R. Branden, Ormond Beach, FL (US)

Correspondence Address: Michael L. Leetzow, Esq.;Michael L. Leetzow, P.A., 5213 SHORELINE CIRCLE, SANFORD, FL, 32771, US

(21) Appl. No.: 10/932,966

(22) Filed: Sep. 2, 2004

Related U.S. Application Data
(63) Continuation-in-part of application No. 29/195,549, filed on Dec. 12, 2003, now Pat. No. D497219.

(51) Int. Cl. B26B 1/00

(52) U.S. Cl. 30/346.54; 30/346.53; 30/346.61

(57) ABSTRACT

A blade that is preferably non-metallic has a middle portion and two outside portions. The outside portions have a variety of configurations and beveled edges to assist in the scraping, cleaning, and peeling of unwanted materials from surfaces.

The present invention relates to a blade, and more particularly, a blade that is preferably non-metallic that has a variety of shapes and beveled edges to scrape, clean, and peel unwanted materials off scratchable or nonscratchable surfaces without scratching the surfaces.

There are prior blades, but none that have the configuration of the present invention, which allows the blade to be used with or without a blade holder. The majority of the prior art blades are made of metal, limiting their use on certain surfaces. Additionally, the majority of the prior art blades are made to be used in one type of holder, but not without a holder.

Accordingly, the present invention is directed to a new and novel blade without one or more of the limitations of the prior art. Additional features and advantages of the invention will be set forth in the description that follows, and in part will be apparent from the description, or may be learned by practice of the invention. The objectives and other advantages of the invention will be realized and attained by the process particularly pointed out in the written description and claims, as well as the appended drawings.

### SUMMARY OF THE INVENTION

To achieve these and other advantages and in accordance with the purpose of the invention as embodied and broadly described herein, the invention is directed to a non-metallic blade that includes a middle portion having a thickness, and two outside portions, each of the outside portions having at least a portion having a thickness greater than the thickness of the middle portion and the middle portion being disposed between the two outside portions.

In another aspect, the invention is directed to a non-metallic blade that includes a first portion having a width, and at least one second portion having a width, the width of the first portion being generally the same as the width of the second portion.

It is to be understood that the foregoing general description and the following detailed description are exemplary and explanatory and are intended to provide further explanation of the invention as claimed.

The accompanying drawings are included to provide a further understanding of the invention and are incorporated in and constitute a part of the specification. The drawings illustrate several embodiments of the invention and together with the description serve to explain the principles of the invention.

### BRIEF DESCRIPTION OF THE DRAWINGS

FIG. 1 is a perspective view of one embodiment of a blade according to the present invention;

FIG. 2 is a top view of the blade of FIG. 1;

FIG. 3 is an end view of the blade of FIG. 1;

FIG. 4 is an end view of another embodiment of a blade according to the present invention;

FIG. 5 is a top view of the blade of FIG. 4;

FIG. 6 is an end view of another embodiment of a blade according to the present invention;

FIG. 7 is an end view of another embodiment of a blade according to the present invention;

FIG. 8 is an end view of another embodiment of a blade according to the present invention;

FIG. 9 is an end view of another embodiment of a blade according to the present invention;

FIG. 10 is an end view of another embodiment of a blade according to the present invention;

FIG. 11 is an end view of another embodiment of a blade according to the present invention;

FIG. 12 is an end view of another embodiment of a blade according to the present invention;

FIG. 13 is an end view of another embodiment of a blade according to the present invention;

FIG. 14 is an end view of another embodiment of a blade according to the present invention;

FIG. 15 is an end view of another embodiment of a blade according to the present invention;

FIG. 16 is a top view of another embodiment of a blade according to the present invention;

FIG. 17 is a top view of another embodiment of a blade according to the present invention;

FIG. 18 is a top view of another embodiment of a blade according to the present invention;

FIG. 19 is a top view of another embodiment of a blade according to the present invention;

FIG. 20 is a top view of another embodiment of a blade according to the present invention;

FIG. 21 is a top view of another embodiment of a blade according to the present invention;

FIG. 22 is a top view of another embodiment of a blade according to the present invention;

FIG. 23 is a partial cross section of the blade of FIG. 22 along the lines 23-23;

FIG. 24 is a partial top view of another embodiment of a blade according to the present invention;

FIG. 25 is a partial top view of another embodiment of a blade according to the present invention; and

FIG. 26 is a partial cross section of the blade in FIG. 24.

### DETAILED DESCRIPTION OF THE INVENTION

FIGS. 1-3 illustrate one embodiment of the blade 100 according to the present invention. Blade 100 preferably has a middle portion 102 and two outside portions 104. The middle portion 102 preferably has an opening 106 and two indents 108 on each side, but need not be present, especially if the blade 100 will not be used with a blade holder. The outside portion 104 of blade 100 also preferably has a beveled edge 110. As will be discussed in detail below, the blade 100 preferably has two beveled edges 110, which can have many different configurations.

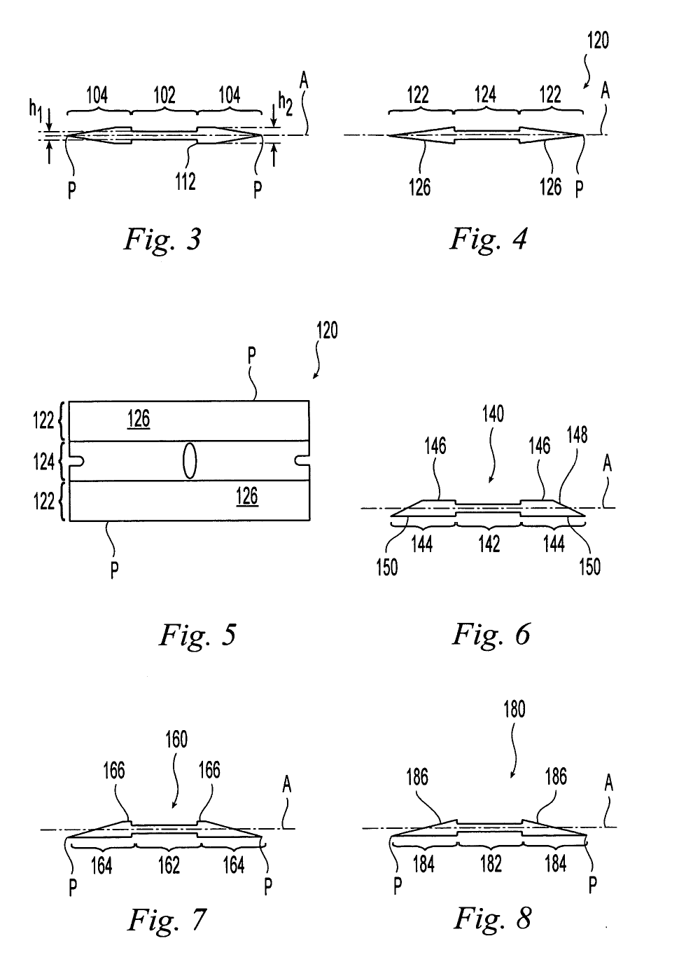

The middle portion 102 has a width W1 that is generally the same as the width W2 of the two outside portions 104. However, the middle portion 102 may have a width W1 that is either smaller or larger than the width W2 of the outside portions and still fall within the scope of the present invention. The middle portion 102 also has a height H1 or thickness that is preferably smaller than the height H2 or thickness at the tallest portion of the outside portion 104 as illustrated in FIG. 3. The middle portion 102 is between the two outside portions 104, preferably with a shoulder 112 therebetween. The shoulder 112 allows the blade 100 to be inserted into and held in a holder that allows a user more leverage and control of the blade 100 than without the holder. However, it should be understood that the blade 100 need not be inserted into a holder to be used.

The beveled edges 110 are located along an outside edge of the outside portion 104 opposite the edge of the shoulder 112. As noted above, the beveled edges 110 can have many different configurations and still fall within the scope of the present invention. As illustrated in FIGS. 1-3, the beveled edges 110 on the blade 100 are symmetrical about the axis A through the blade 100 and come to a sharp edge at point P that lies on the axis A. It should also be noted that the outside portion 104 of blade 100 preferable has relatively flat portions 114 between the beveled edges 110 and the shoulder 112. The flat portions 114 may be bigger or smaller than illustrated in FIGS. 1-3, as illustrated in FIGS. 4 and 5, where blade 120, which is generally similar to blade 100, has little to no flat portion on the outside portions 122. It should also be noted that the flat portions need not be the same size, but could be of different heights, widths, etc. Like blade 100, blade 120 has a middle portion 124 that is about the same width as the outer portion 122 and is generally thinner than the outside portions 122 at their thickest points. The beveled edges 126 also comes to an edge or point P on the axis A through the blade 120.

The beveled edges 110 and 126 preferably have an angle relative to the axis A of between about 1° and 90°, more preferably between 5° and 45°, and most preferably 5° and 20°.

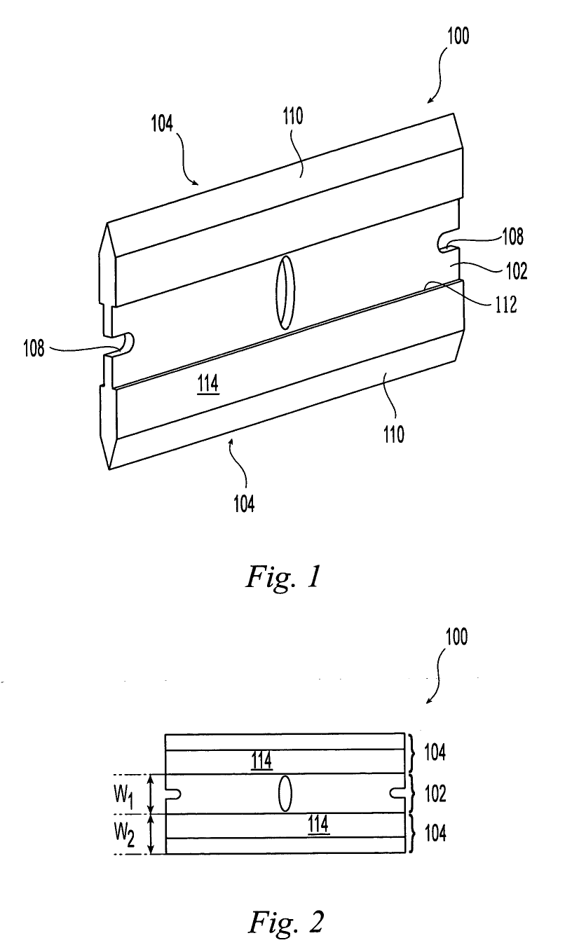

Another embodiment of a blade 140 according to the present invention is illustrated in FIG. 6. It should be noted that the top view of blade 140, as well as the other blades discussed below, would generally appear to be the same as that in FIGS. 2 and 5. Therefore, the top views of those blades have not been included here. However, as would be recognized by one of ordinary skill in the art, they would generally have the same configuration except as noted below.

The blade 140 preferably has a middle portion 142 and outside portions 144. As with the other embodiments discussed above, the middle portion 142 of the blade 140 is between the outside portions 144 and is thinner than the thickest parts of the outside portions 144. As with blade 100, the outside portions 144 of blade 140 have relatively flat portions 146. However, in this embodiment, blade 140 has a beveled edge 148 on only one side. The beveled edge 148 of blade 140 comes to a point P on one side of the axis A rather than coming to a point P on the axis as in the previous embodiments. This configuration of blade 140 means that one side has a relatively flat portion 150 along the entire width of the outside portion 144.

Similar blades are illustrated in FIGS. 7 and 8. In FIG. 7, blade 160 has a middle portion 162 between two outside portions 164. As with the other embodiments, middle portion 162 is thinner than the thickest portions of the outside portions 164 and is about the same width as those outside portions 164. Blade 160 has a smaller relatively flat portions 166 than blade 140. As with blade 140, the point P for both of the outside portions 164 is on the same side of the axis A, rather than being on the axis.

In FIG. 8, blade 180 also has a middle portion 182 between two outside portions 184. Similarly, middle portion 182 is thinner than the thickest portions of the outside portions 184 and is about the same width as the outside portions 184. Blade 180 preferably has no relatively flat portions on the one side of blade 180 as the beveled edge 186, meaning that the beveled edge runs the entire width of the outside portion 184 on the one side of the blade 180. As with blade 160, the point P for both of the outside portions 184 is on the same side of the axis A, rather than being on the axis.

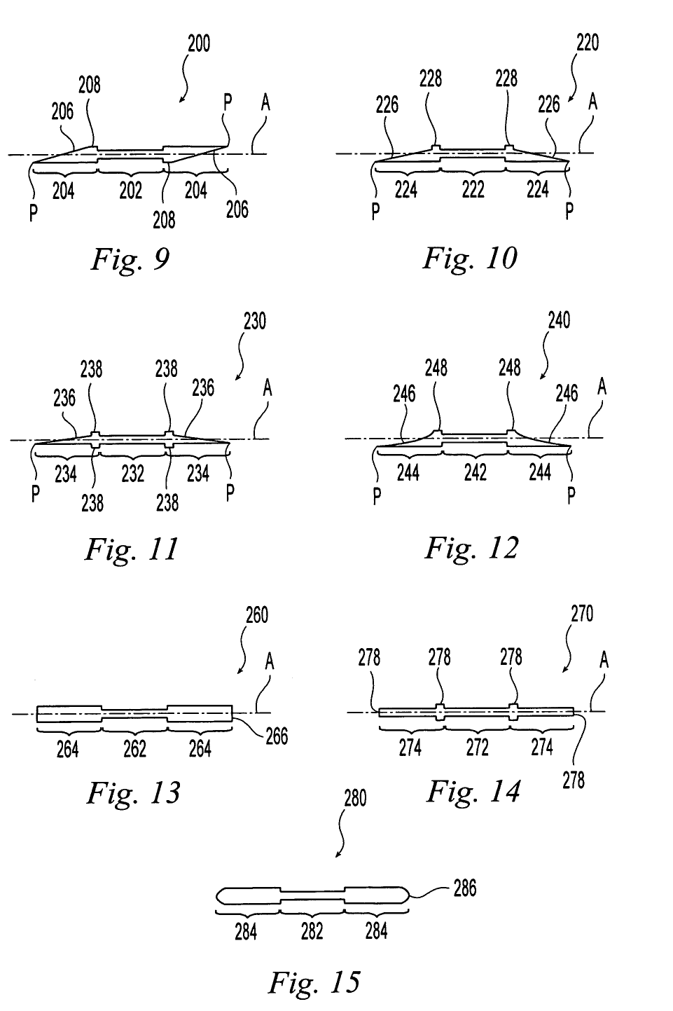

FIG. 9 illustrates another embodiment of a blade according to the present invention. Blade 200 has a middle portion 202 between two outside portions 204. The middle portion 202 is preferably thinner than the thickest portions of the outside portions 204. The blade 200 also has two beveled edges 206, which come to an edge or point P. However, in this embodiment, the two points P for the opposite sides of blade 200 are on opposite sides of the axis A that passes through the center of blade 200. While the outside portions 204 have a relatively flat portion 208 on the side with the beveled edge 206, there could be a smaller or larger relatively flat portion 208 and still fall within the scope of the present invention. For example, the outside portions 204 could be configured like those outside portions 144,184 on blades 140,180, but with their respective points P on opposite sides of the axis A.

Blade 220 illustrated in FIG. 10 is another embodiment of a blade according to the present invention. Blade 220 preferably has a middle portion 222 between two outside portions 224. The middle portion 222 is preferably thinner than the thickest portions of the outside portions 224. Outside portions 224 also have a beveled edge 226, but also have a raised, flat portion 228 that is slightly higher than the rest of the outside portion 224 on the side of the blade 220 with the beveled edge 226. This flat portion 228, while about the same height as the thickest portions of the outside portions in the other embodiments, allows for a holder to engage the blade 220, but still allows for a smaller overall profile of outside portions 224.

Blade 230, illustrated in FIG. 11, preferably has a middle portion 232 between two outside portions 234. As with the prior embodiment, the outside portions 234 have beveled edges 236 that come to a sharp edge or point P on one side of the axis A. However, as noted above for blade 200, the sharp edge or point P cold be on opposite sides of axis A. The majority of outside portions 234 are about the same thickness as the middle portion 232, but each of the outside portions 234 have a shoulder 238 on both sides of blade 230, rather than just on one side as with blade 220 and raised, flat portion 228, making the beveled edges thinner than in the other embodiments.

Blade 240, illustrated in FIG. 12, preferably has a middle portion 242 between two outside portions 244. As with the blade 140 illustrated in FIG. 7, the outside portions 244 have beveled edges 246 that come to a sharp edge at point P on one side of the axis A. The beveled edges 246 are sloped from a flat, raised portion 248 on the outside portion 244 toward the edge at point P. It should be noted that while the blades with both edges on the same side of the axis A (e.g., blades 140,180,220,230,240), they could also have one of the sharp edges on each side of axis A as with blade 200, illustrated in FIG. 9. It should also be noted that each of the embodiments in FIGS. 1-15 have a shoulder (like shoulder 112) between the middle and the outside portions as indicated in FIG. 3.

Three more embodiments of blades according to the present invention are illustrated in FIGS. 13-15 with these blades having relatively blunt edges rather than the sharp edges in the previous embodiments. For example, blade 260, like the other embodiments, preferably has a middle portion 262 between two outside portions 264. The outside portions 264 has a generally consistent thickness across the width of the outside portions 264, which is thicker than the middle portion 262. The outside edges 266 are generally perpendicular to the axis A through the blade 260.

Blade 270, illustrated in FIG. 14, also preferably has a middle portion 272 between two outside portions 274, each of the outside portions 274 have a raised, flat portion 276 adjacent the middle portion 272. The outside edges 278 are, like the previous embodiment, also generally perpendicular to the axis A through the center of the blade 270.

The blade 280 in FIG. 15 preferably has a middle portion 282 between two outside portions 284 as with blade 260. However, blade 280 has rounded outside edges 286, rather than the generally perpendicular edges 278 in the previous embodiment. While the rounded edges 286 are generally circular in configuration, they could be of any rounded shape, e.g., oval, elliptical, etc.

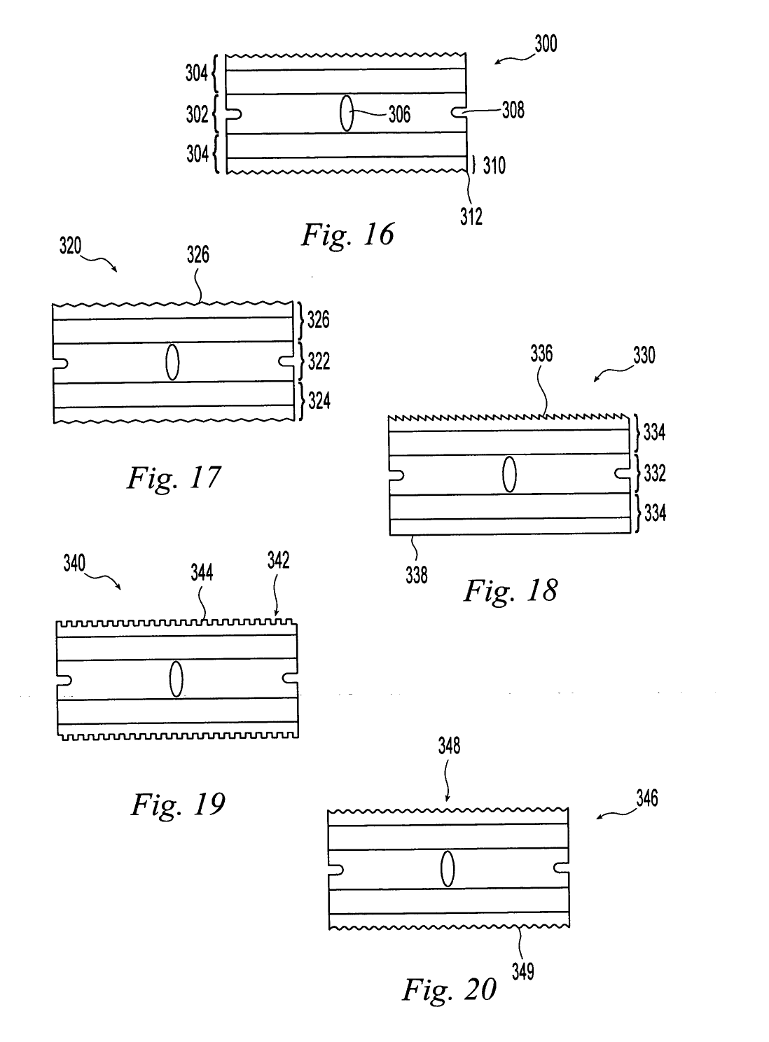

A top view of another embodiment of a blade 300 is illustrated in FIG. 16. The blade 300 has a similar configuration to that of blade 100 in FIGS. 1-3. That is, the blade 300 preferably has a middle portion 302 and two outside portions 304. The middle portion 302 preferably has an opening 306 and two indents 308 on each side. The outside portion 304 of blade 300 also preferably has a beveled edge 310. The outside edge of blade 300 however has serrations 312, rather than the straight, smooth edge of the blade 100 in FIGS. 1-3. While the configuration of the blade 300 has the bevel on only a part of the outside portion 304, the beveled edge could extend the width of the outside portion 304 as illustrated in FIG. 4 on blade 120, or it could extend for only a small portion of outside portion 304 (e.g., as with blade 160 in FIG. 7).

Another blade 320 is illustrated in FIG. 17 with a middle portion 322 and two outside portions 324. Blade 320 is similar to the blade 300, but has fewer serrations 326 than blade 300. Any number, frequency, or depth of the serrations on the outside edges of the blades is within the scope of the present invention. The serrations 312,324 on blades 300,320 can be used on any of the other blades discussed within this application and still be within the scope of the present invention. Also, the beveled edges on opposite sides of the middle portions of each of the blades, as noted above with certain of the embodiments, can be on opposite sides or even the same side of the axis A through the blade and still fall within the scope of the present invention.

Another blade 330, illustrated in FIG. 18, has at least one non-smooth edge. Blade 330 has, as with the other blades, a middle portion 332 and two outside portions 334. However, blade 330 preferably has at least one edge with a saw-tooth edge 336. The blade 330 also preferably has one smooth, straight edge 338, although any configuration on either edge could be used. For example, the two edges could have one blunt edge (like edge 226) and one serrated edge (like serrations 312) or one blunt edge and one sharp, smooth edge.

Another embodiment of a blade according to the present invention is illustrated in FIG. 19. Blade 340 illustrates that the beveled edge 342 may have square serrations 344, rather than the pointed serrations 326 or the saw-tooth serrations 336 in the previous two embodiments. The square serrations 344 may be used with any of the other of the blades that have been disclosed and described herein.

Another embodiment of a blade according to the present invention is also shown in FIG. 20. Blade 346 illustrates that the beveled edge 348 may have a wavy serrated edge 349, rather than the pointed serrations 344, the saw-tooth serrations 336, or the square serrations 344 described above.

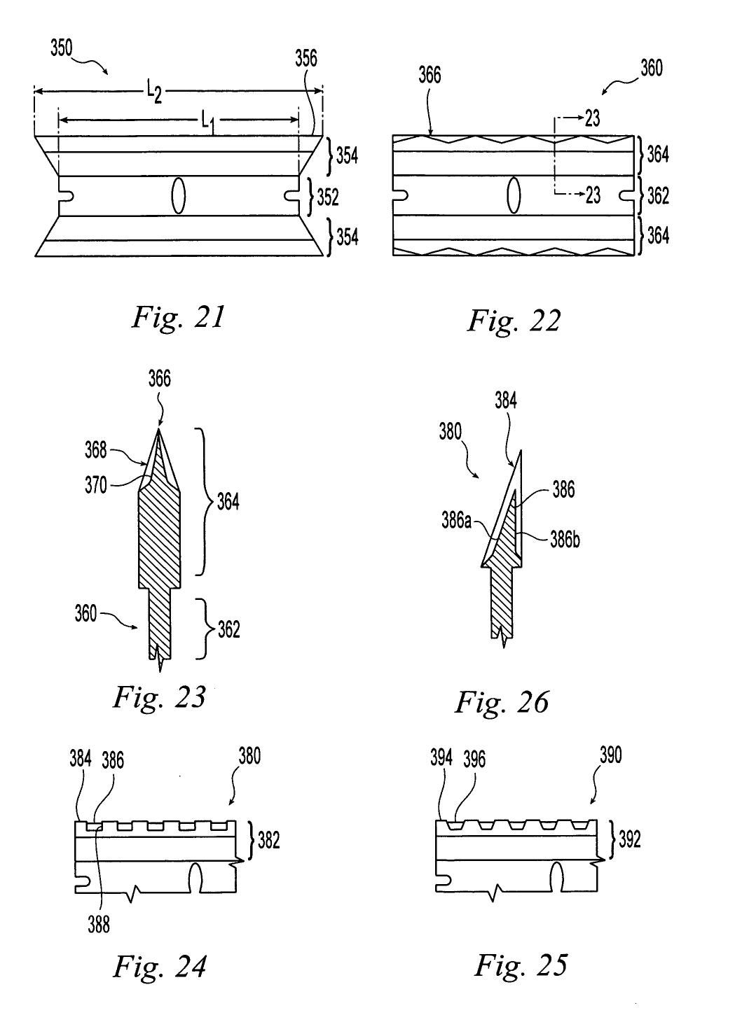

Blade 350 is illustrated in FIG. 21 having a differently shaped configuration from the prior embodiments. Blade 350 preferably has a middle portion 352 and two outside portions 354. The two outside portions 354 have a outside edge 356 having a length L1 that is longer, while the outside portion 354 adjacent the middle portion 352 has the same length L1 as the middle portion 352. Blade 350 allows the user to get one of the comers of blade 350 into tight places to assist with the scraping, cleaning, and peeling of unwanted materials. The edges 356, while shown to be straight, smooth edges, could also have any configuration, including one of the configurations of FIGS. 13-18. While blade 350 has an end profile similar to that in FIG. 3, blade 350 could have any of the profiles that have been described and shown in the present application (FIGS. 1-20).

Another blade 360 according to the present invention is shown in FIGS. 22 and 23. The blade 360 generally has the same configuration as that of blade 100 in FIGS. 1-3, in that it has a middle portion 362 and two outer portions 364, but it has a different configuration for the beveled edge 366. As better illustrated in FIG. 23, the beveled edge 366 has two portions 368,370 having different angles relative to a center line through the blade. This configuration in blade 360 also allows the blade to be used to cut if the blade 360 is moved along the edge 366 due to the difference in height of two portions 368,370.

Two other edge configurations that can be used with any of the blades are illustrated in FIGS. 24-26. Blade 380, partially illustrated in FIG. 24, has at the beveled edge portion 382 a break in the leading edge. The blade 380 has a leading edge portion 384 that may have any of the configurations or profiles noted herein, e.g., straight, wavy, saw-toothed, serrated, etc. However, there is also a set back portion 386, that has a leading edge behind that of the leading edge portion 384. The overall configuration of this blade is a saw-tooth-like configuration, with a transition edge 388 between the leading edge portion 384 and the set back portion 386 at about a 90° angle. Similarly, blade 390 also has leading edge portion 394 on beveled edge portion 392, with a set back portion 396. The set back portion 396 in this embodiment of the blade 390 has a transition edge 398 that is at about a 45° angle relative to the leading edge portion 394, although any angle could be used.

A cross section of one embodiment of the blade 380 is illustrated in FIG. 26. In the embodiment shown in FIG. 26, the set back portion 386 has a top 386a and bottom surface 386b that is on a different plane than that for the top and bottom surfaces of beveled edge 384. However, bottom surface 386b (or even the top surface 386a) could also be coplanar with the beveled edge 384. Also, the blade 380 is depicted as one side having a flat portion, but the blade 380 (and blade 390) could have any of the overall configurations as noted above.

The blades according to the present invention are preferably made from plastic. However, any non-metallic material could be used, including, for example, nylon, fiberglass, graphic, ceramic, or any composite materials.

It will be apparent to those skilled in the art that various modifications and variations can be made to the mechanism according to the present invention without departing from the spirit or scope of the invention. Thus, it is intended that the present invention cover the modifications and variations of this invention provided they come within the scope of the appended claims and their equivalents.

1. A non-metallic blade comprising:
a middle portion having a thickness; and
two outside portions, each of the outside portions having at least a portion having a thickness greater than the thickness of the middle portion and the middle portion being disposed between the two outside portions.

2. The non-metallic blade according to claim 1, wherein each of the outside portions has at least a portion with a beveled edge.

3. The non-metallic blade according to claim 2, wherein the beveled edge has an angle of between 5 and 30 degrees.

4. The non-metallic blade according to claim 2, wherein the beveled edge has a configuration selected from the group of serrated, straight, wavy, and saw-toothed.

5. The non-metallic blade according to claim 2, wherein the blade has a longitudinal axis through the middle and outside portions, and each of the beveled edges come to a point on one side of the longitudinal axis

6. The non-metallic blade according to claim 2, wherein the blade has a longitudinal axis through the middle and outside portions, and each of the beveled edges come to a point on differing sides of the longitudinal axis.

7. The non-metallic blade according to claim 2, wherein the blade has a longitudinal axis through the middle and outside portions, and each of the beveled edges come to a point on the longitudinal axis.

8. The non-metallic blade according to claim 1, further comprising a shoulder between the middle and outside portions.

9. The non-metallic blade according to claim 1, wherein the middle portion has a first width and the outside portions have a second width, the first width and the second width being unequal.

10. The non-metallic blade according to claim 1, wherein the middle portion has a first width and the outside portions have a second width, the first width and the second width being equal.

11. The non-metallic blade according to claim 1, wherein the middle portion has a first length and the outside portions have at least a portion having a second length, the second length being longer than the first length.

12. A non-metallic blade comprising:
a first portion having a width; and
at least one second portion having a width, the width of the first portion being generally the same as the width of the second portion.

13. The non-metallic blade according to claim 12, wherein the at least one second portion comprises two second portions, the first portion being disposed between the two second portions.

14. The non-metallic blade according to claim 13, further comprising a shoulder between the first portion and each of the two second portions.

15. The non-metallic blade according to claim 12, wherein each of the at least one second portions has a beveled edge.

16. The non-metallic blade according to claim 15, wherein the beveled edge has an angle of between 5 and 30 degrees.

17. The non-metallic blade according to claim 15, wherein the beveled edge of each of the at least one second portions has a configuration selected from the group of serrated, straight, wavy, and saw-toothed.

18. The non-metallic blade according to claim 15, wherein the blade has a longitudinal axis through the first portion and the at least one outside portion, and each of the beveled edges come to a point on one side of the longitudinal axis

19. The non-metallic blade according to claim 15, wherein the blade has a longitudinal axis through the first portion and the at least one second portion, and each of the beveled edges come to a point on one differing sides of the longitudinal axis.

20. The non-metallic blade according to claim 15, wherein the blade has a longitudinal axis through the first portion and the at least one second portion, and each of the beveled edges come to a point on the longitudinal axis.
